(19) United States
(12) Patent Application Publication
(10) Pub. No.: US 2012/0314430 A1
(43) Pub. Date: Dec. 13, 2012

(54) MODULAR HEAT SINK

(76) Inventor: Forrest Starnes McCanless, Oxford, GA (US)

(21) Appl. No.: 13/156,579

(22) Filed: Jun. 9, 2011

(51) Int. Cl. F21V 21/00; F28F 7/00; B21D 53/02; F21V 29/00

(52) U.S. Cl. 362/382; 165/185; 29/890.03

(57) ABSTRACT

Modular heat sinks formed by a plurality of interlocked modules. The modules include fins that define channels. In some embodiments, the fins and channels extend along an axis that is not parallel to an axis in which the heat sink extends and/or to a plane in which one of the top or bottom walls of at least one module of the heat sink extends. In some embodiments of the heat sink, the channels extend through the thickness of the heat sink to allow air easily to enter the channels from below and pass through and exit the channels from above to facilitate heat dissipation.

### FIELD

Embodiments of the present invention relate to modular heat sinks.

### BACKGROUND

Thermal management is of paramount importance in luminaire design. The light sources used in luminaires heat up during use, which can detrimentally impact the efficiency and life expectancy of such light sources. Heat sinks have been incorporated in luminaires to facilitate heat dissipation from the light sources. Such heat dissipation can result both from conduction of heat from the light sources via the heat sink material as well as conduction of heat from the heat sink to the air circulating through and around the heat sink. Such air consequently heats up and rises, thereby carrying heat away from the luminaire via convection.

Many heat sinks are provided with fins defining channels formed between adjacent fins. Many such heat sinks, however, are designed so that, when installed in the luminaire, the fins extend parallel to the luminaire in a more horizontal direction in alignment with the luminaire. This renders it difficult for heated air to escape the channels during the convection process or for cooler air to enter the channels to replace the heated air. Rather, conduction of heat from the heat sink to the air and convection of the heated air away from the heat sink is concentrated primarily at the tips of the fins, farthest from the heat source. Thus, more fins and fins of greater size must be provided on heat sinks for adequate cooling.

### SUMMARY

Certain embodiments of the present invention provide modular heat sinks formed by a plurality of interlocked modules. The modules include fins that define channels. In some embodiments, the fins and channels extend along an axis that is not parallel to an axis in which the heat sink extends and/or to a plane in which one of the top or bottom walls of at least one module of the heat sink extends. In some embodiments of the heat sink, the channels extend through the thickness of the heat sink to allow air easily to enter the channels from below and pass through and exit the channels from above to facilitate heat dissipation.

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

### BRIEF DESCRIPTION OF THE FIGURES

Illustrative embodiments of the present invention are described in detail below with reference to the following drawing figures:

FIG. 1 is a top perspective view of a modular heat sink according to an embodiment of the invention.

FIG. 2 is a top plan view of the modular heat sink of FIG. 1.

FIG. 3 is a top plan view of an embodiment of a module shown in FIGS. 1 and 2.

FIG. 4 is a top plan view of an embodiment of another module shown in FIGS. 1 and 2.

FIG. 5 is a top plan view of an embodiment of still another module shown in FIGS. 1 and 2.

FIG. 6 is a top perspective view of a modular heat sink according to another embodiment of the invention.

FIG. 7 is a top perspective view of a modular heat sink according to still other embodiment of the invention.

FIG. 8 is a perspective view of an embodiment of a module shown in FIG. 7.

FIG. 9 is a top plan view of the module shown in FIG. 8.

FIG. 10 is a top perspective view of an embodiment of a lighting assembly according to an embodiment of the invention.

FIG. 11 is a bottom perspective view of a lighting assembly according to another embodiment of the invention.

FIG. 12 is a bottom plan view of the lighting assembly of FIG. 11.

FIG. 13 is a perspective view of a module profile according to an embodiment of the invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Certain embodiments of the present invention provide modular heat sinks that may be, but certainly do not have to be, oriented in a luminaire so that the channels formed between the fins are not aligned with an axis of the luminaire or a plane in which the luminaire extends. In some embodiments, the channels formed between the fins are oriented substantially perpendicular to an axis of the luminaire.

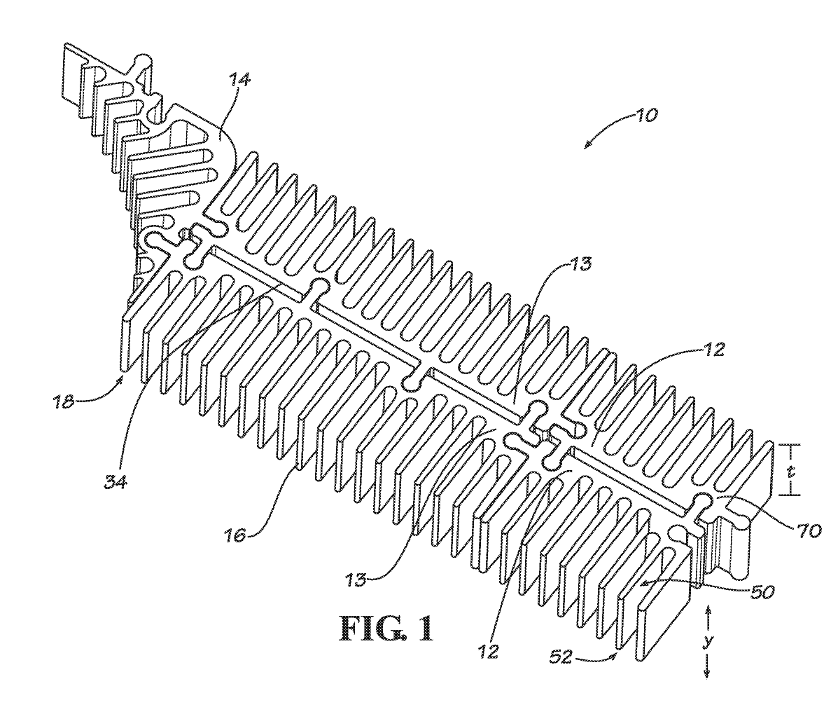

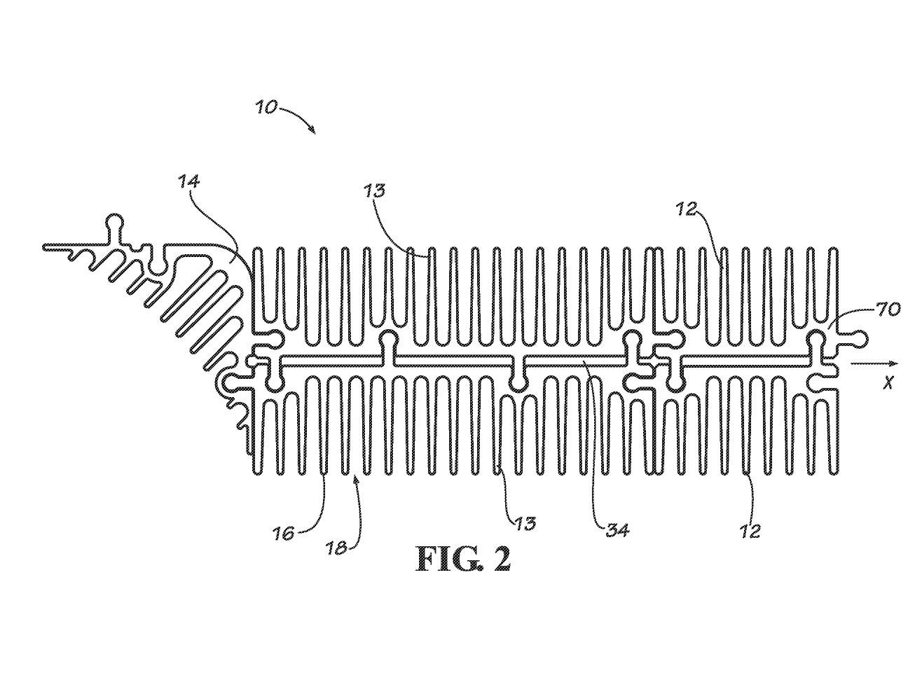

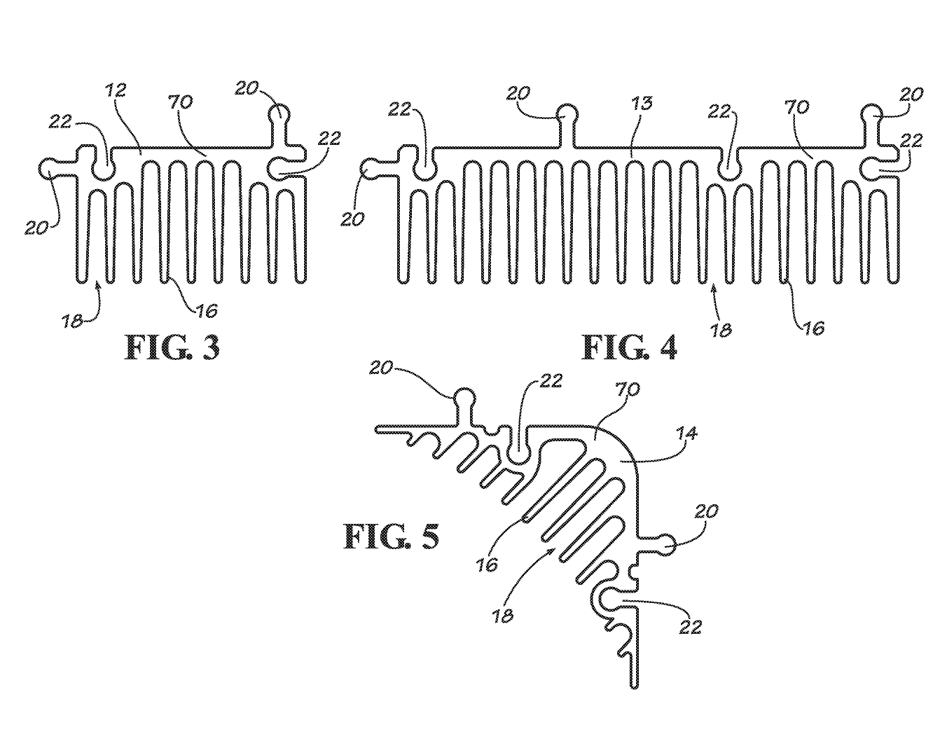

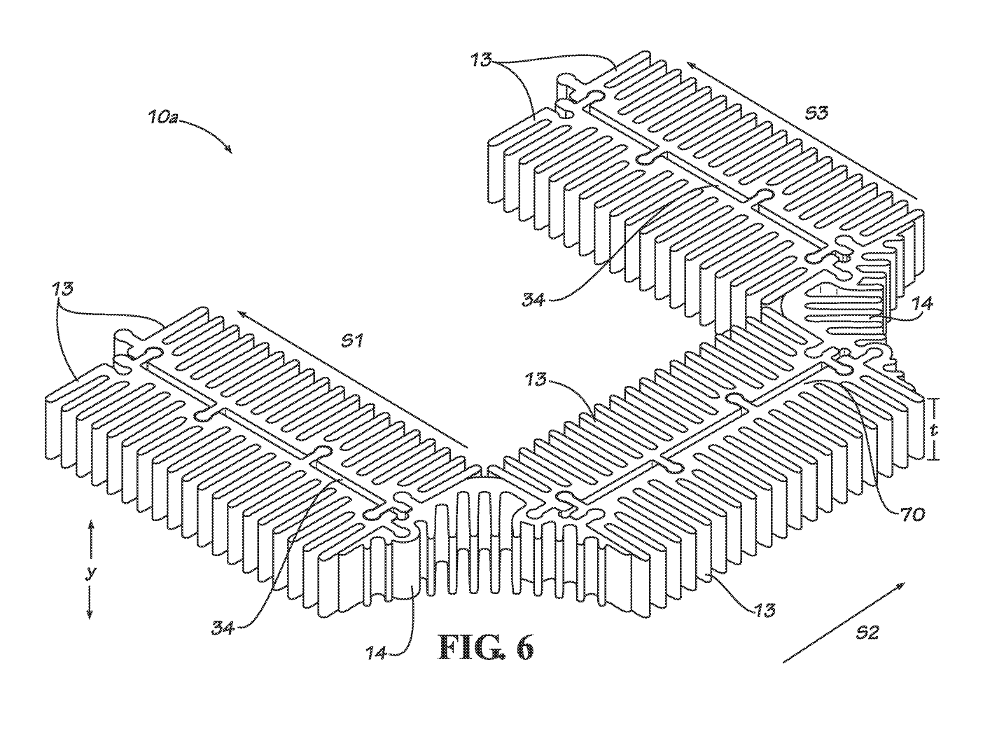

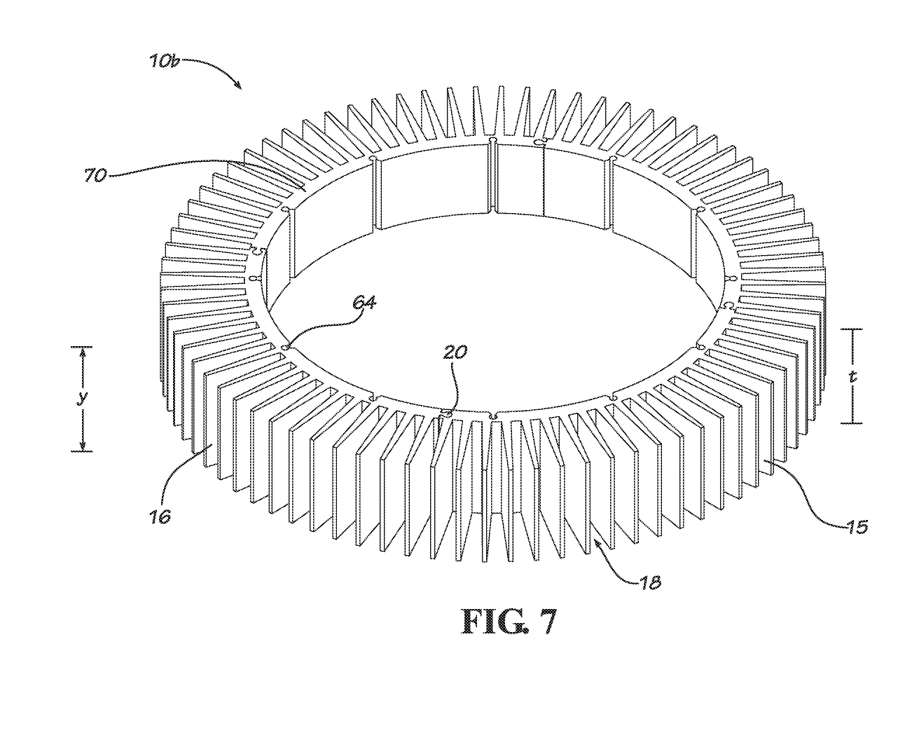

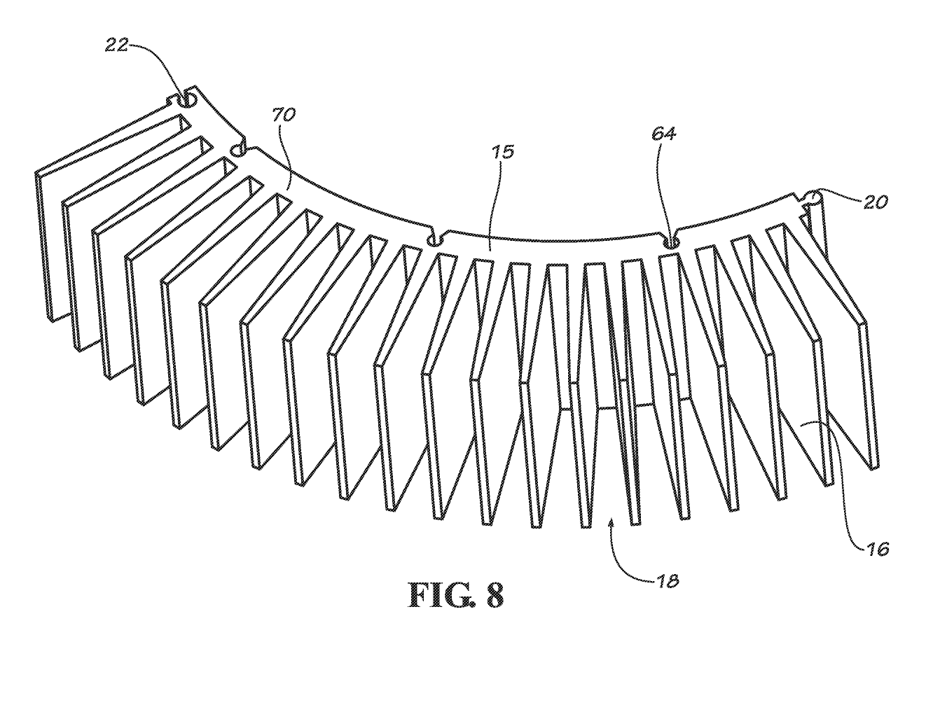

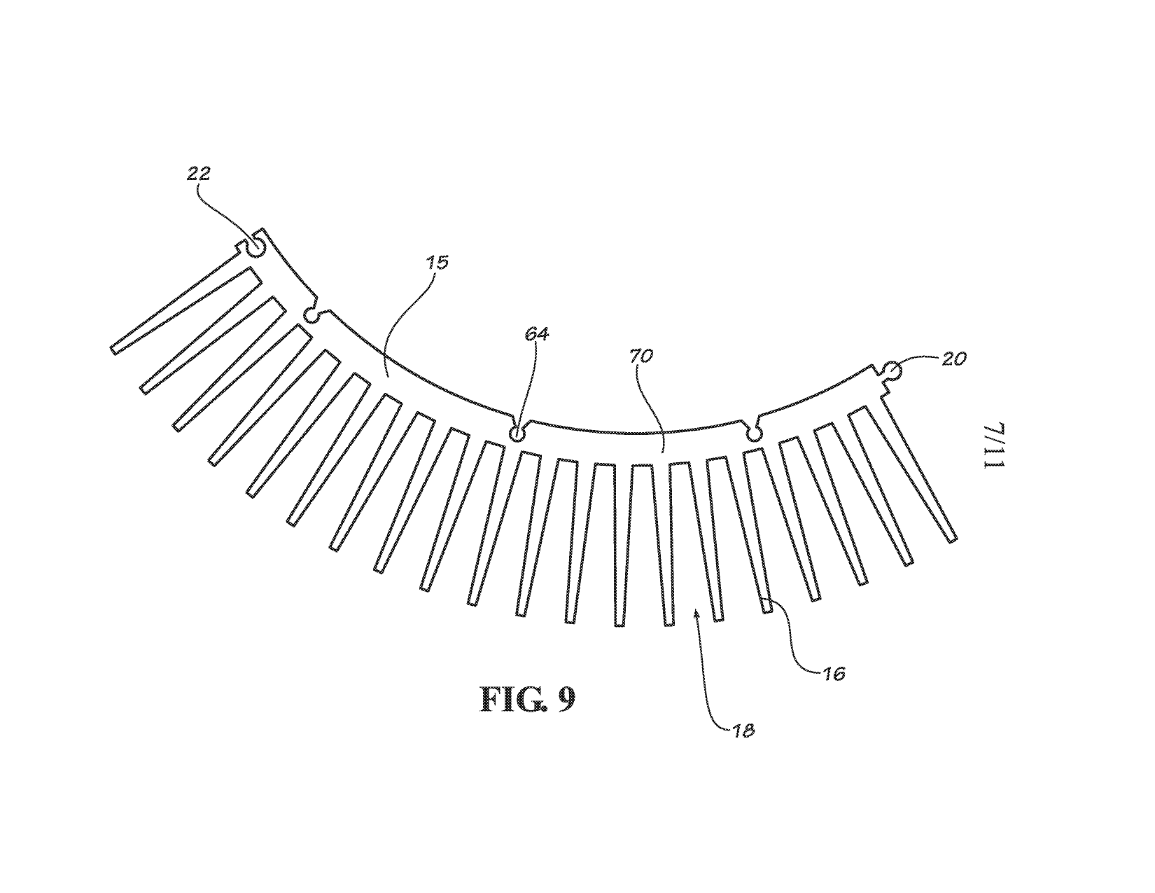

FIGS. 1 and 2 illustrate a modular heat sink 10 according to one embodiment. The heat sink 10 illustrated in this embodiment includes two modules 12 (shown in isolation in FIG. 3), two modules 13 (shown in isolation in FIG. 4), and a module 14 (shown in isolation in FIG. 5). Any number of modules may be assembled together to form the heat sink 10. FIG. 6 illustrates an alternative embodiment of a modular heat sink 10a formed with six modules 13 and two modules 14. FIG. 7 illustrates another embodiment of a modular heat sink 10b formed with curved modules 15 (shown in isolation in FIGS. 8 and 9), which are assembled in this embodiment to form a circular modular heat sink 10b.

Modules having any shape or profile are contemplated herein, and this invention is in no way intended to be limited to those module profiles shown in the figures, which are included purely for illustrative purposes. Moreover, any combination of modules may be combined to form a modular heat sink of any shape. Modules of different sizes and shapes may be joined together to customize a desired heat sink configuration.

In some embodiments, the modules include a plurality of fins 16, whereby adjacent fins 16 form channels 18. The modules include a top wall 70 and a bottom wall (not labeled) that can (but do not have to) extend in parallel planes, whereby the fins 16 and channels 18 extend between the top wall 70 and the bottom wall. In some embodiments, the fins 16 and channels 18 extend along an axis y that is not parallel (and can be, but does not have to be, substantially perpendicular) to one of the planes in which the top wall 70 and/or bottom wall of a module extends.

In some embodiments, the modules may, but do not have to, include tongues 20 and grooves 22 by which adjacent modules may be joined. One of skill in the art will readily understand, however, that the modules may be joined together via an mechanical interlocking method and by no means are embodiments of the heat sinks disclosed herein intended to be limited to the specific tongue and groove configurations illustrated. In some embodiments, the modules are separable from each other so that the heat sink configuration may be modified if desired.

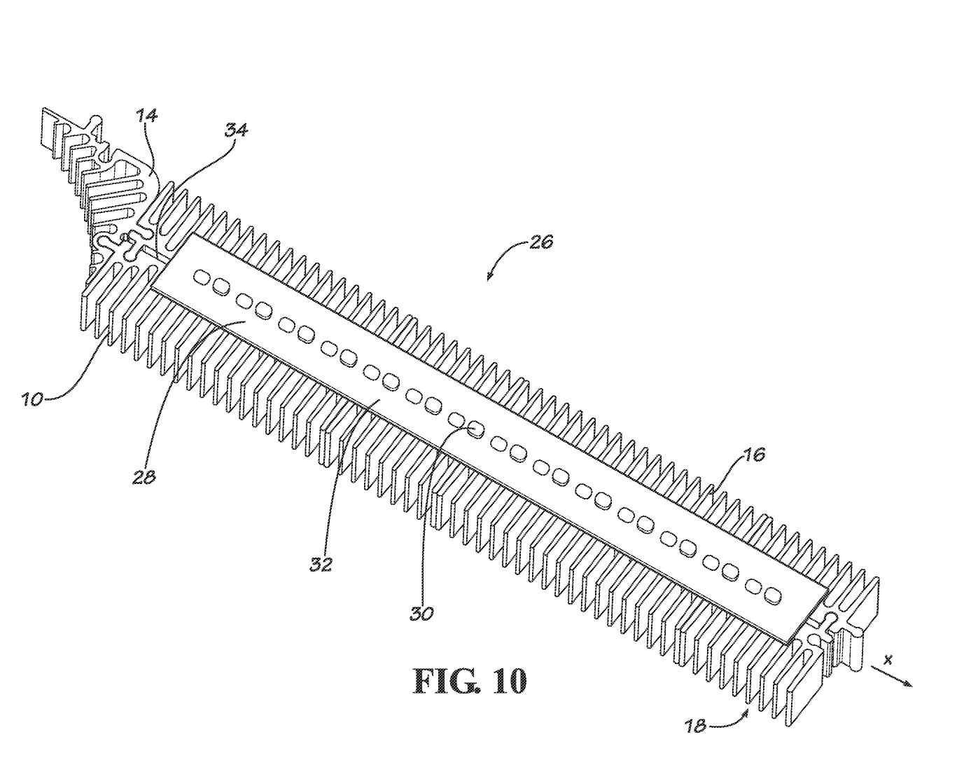

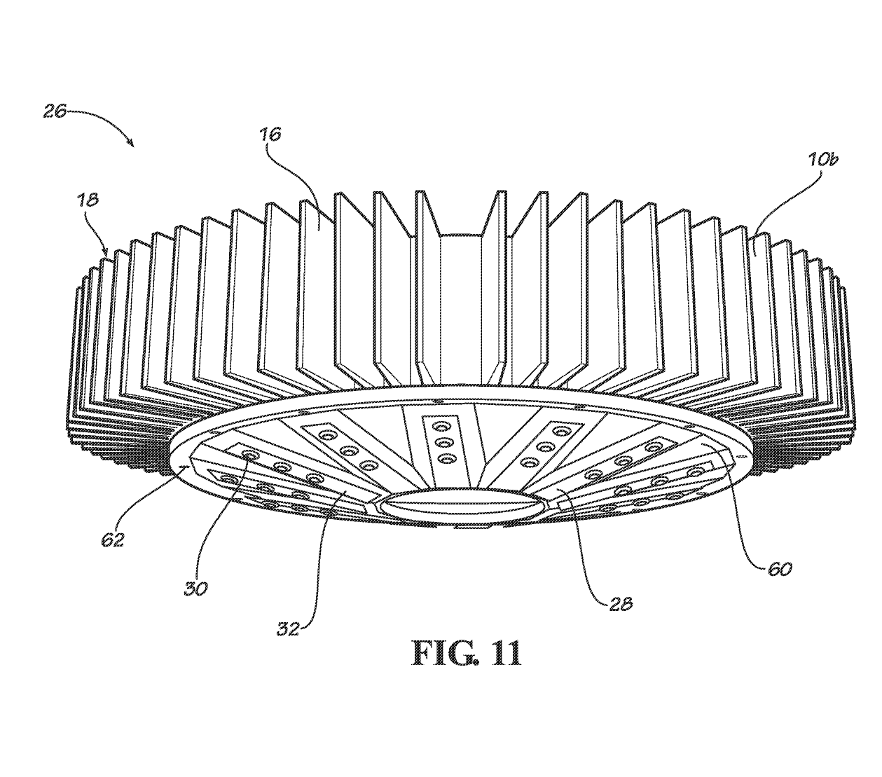

FIG. 10 illustrates an embodiment of a lighting assembly 26 for incorporation into a luminaire (not shown). The lighting assembly 26 includes the modular heat sink 10 of FIG. 1, which extends in a plane along axis x. The lighting assembly 26 also includes at least one light source 28 (shown as, but not limited to, light emitting diodes 30 positioned on a printed circuit board (“PCB”) 32) mounted on the modular heat sink 10. The light sources 28 are illustrated mounted on the modular heat sink 10 of FIG. 1, but may be mounted on any modular heat sink configuration. By way only of example, the light sources 28 could be mounted on heat sink 10a shown in FIG. 6, which extends in a plane along multiple axes S1, S2, and S3.

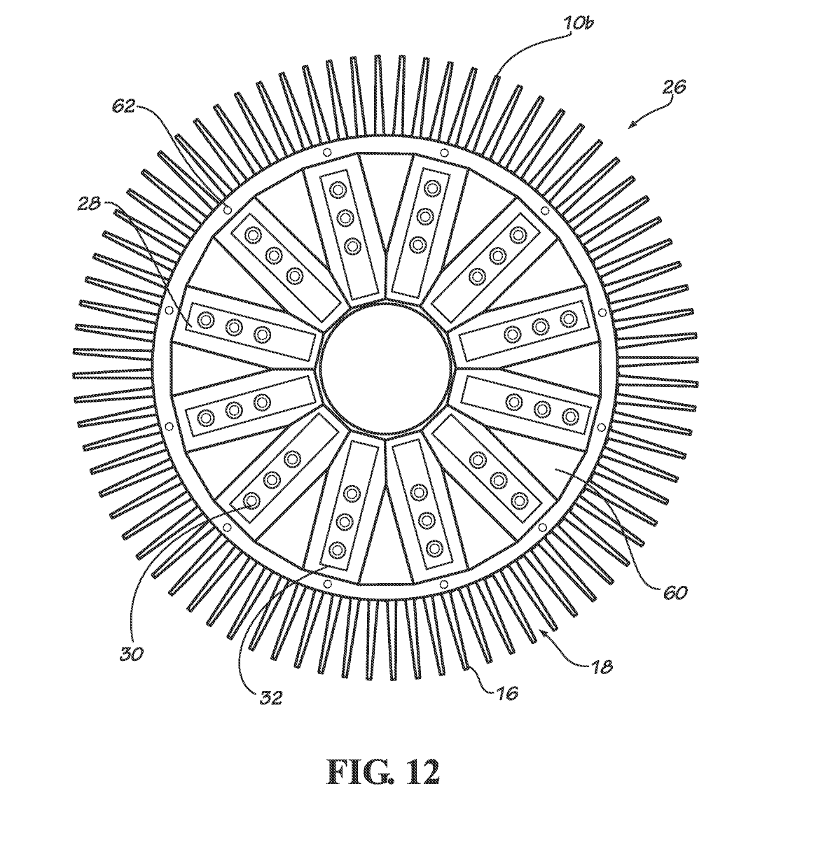

In an alternative embodiment (shown in FIGS. 11 and 12), the light sources 28 are mounted on the circular heat sink 10b shown in FIG. 7. In the illustrated embodiment, the light sources 28 radiate outwardly from the center of the lighting assembly 26. However, the light sources 28 may be provided in any orientation relative to the circular heat sink 10b. A heat conductive mounting plate 60 can be, but need not be, interposed between the light sources 28 and the heat sink 10b. The mounting plate 60 may be attached to the circular heat sink 10b in a variety of ways. In the illustrated embodiment, the mounting plate 60 is attached to the circular heat sink 10b via screws 62. By way only of example, apertures 64 are provided on modules 15. Screws 62 may be inserted through apertures in the mounting plate 60 and into apertures 64 located on the modules 15 of circular heat sink 10b.

In some embodiments, slots or apertures 34 may arise at the joint between adjoining modules. The slots or apertures 34 may receive fasteners, such as, but not limited to, pins and screws (not shown), for securing adjacent modules together and/or mounting the light sources 28 to the modular heat sink 10 as well as other components of the luminaire.

When so assembled, the fins 16 project laterally outwardly from axis x (or an axis S1-S3 of heat sink 10a or the center of circular heat sink 10b). The fins 16 and channels 18 extend along an axis y that is not parallel (and can be, but does not have to be, substantially perpendicular) to an axis in which the heat sink extends and/or to a plane in which one of the top or bottom walls of at least one module of the heat sink extends.

In some embodiments, axis y is substantially parallel to the direction at which light is emitted from the light source. Moreover, in some embodiments the channels 18 extend along axis y entirely through the thickness t of the modules forming the heat sink 10 such that there are channel openings at both the top 50 and bottom 52 of the heat sink. When the assembly 26 is incorporated into a luminaire, the channels 18 can, but do not have to, extend substantially vertically. Extension of a channel 18 through the thickness t of the heat sink 10 enables heated air to escape unimpeded upwardly through the top opening 50 of the channel 18 to carry heat away and cooler air easily to enter the channel 18 through the bottom opening 52 of the channel so as to be available to accept heat from the heat sink. In short, air may easily enter the channels 18 from below and pass through the heat sink to facilitate heat dissipation.

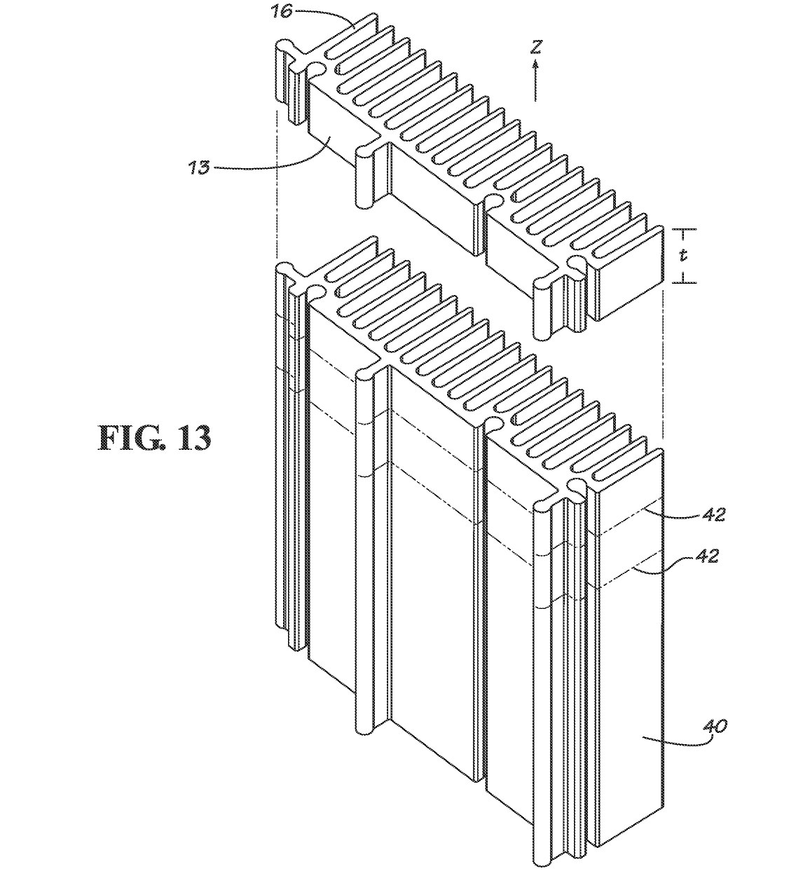

The individual modules may be formed of any heat-conducting material including any metallic material, such as aluminum. Moreover, they may be formed in a variety of ways, including (but not limited to) extruding, molding, casting, and forging. In one embodiment, the modules are formed by (1) extruding a module profile 40 in an extrusion direction z so that the fins 16 of the profile 40 extend in the extrusion direction z, (2) slicing the profile 40 into modules by cutting through the profile 40 along cut lines 42 oriented substantially orthogonal to the extrusion direction z so that the fins 16 of the resulting modules (illustrated in FIG. 13 as modules 13) have the desired thickness t, and (3) then re-assembling the modules to form the desired modular heat sink. When so re-assembled, the extrusion direction z will be aligned with or parallel to axis y. Provision of interlocking mechanisms (such as, but not limited to, tongues 20 and grooves 23) may be, but do not have to be, formed directly in the profile 40 during the extrusion process. In other embodiments, the means by which adjacent modules are attached may be non-integral with the modules.

Modules may be made by extruding the profile and then cutting the profile along its length so that the resulting modules have the desired thickness t. By controlling the location of the cut, the thickness t of the modules and thus the surface area available for heat transfer may be customized.

The heat sinks contemplated herein may be incorporated into luminaires. When so incorporated, the channels 18 of the heat sink will be oriented to allow air easily to enter the channels 18 from below and pass through and exit the channels 18 from above to facilitate heat dissipation. Oftentimes, the heat sinks will be oriented in a substantially horizontal plane (such as relative to the ceiling or floor of a space in which the luminaire is installed) and the axis y of the channels will extend substantially vertically to facilitate air flow through the heat sink channels. However, it is contemplated that the heat sinks disclosed herein may be provided in any orientation in a luminaire and need not be horizontally oriented.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

I claim:

1. A modular heat sink comprising a plurality of interlocked modules, wherein at least a portion of the heat sink extends along a first axis and wherein at least one of the plurality of modules comprises a plurality of fins defining channels that extend along a second axis different from the first axis.

2. The modular heat sink of claim 1, wherein the second axis is substantially orthogonal to the first axis.

3. The modular heat sink of claim 1, wherein the first axis is substantially horizontal and the second axis is substantially vertical when the modular heat sink is positioned within a luminaire.

4. The modular heat sink of claim 1, wherein the interlocked modules are separable from each other.

5. The modular heat sink of claim 1, wherein the interlocked modules are interlocked via tongue and groove interaction.

6. The modular heat sink of claim 1, wherein the at least one module comprises a thickness and wherein at least some of the channels extend through the thickness of the at least one module.

7. The modular heat sink of claim 1, wherein the fins project laterally outwardly from the first axis.

8. A lighting assembly comprising:
a. a light source; and
b. a heat sink comprising a plurality of interlocked modules, wherein at least a portion of the heat sink extends along a first axis and wherein at least one of the plurality of modules comprises a plurality of fins defining channels that extend along a second axis different from the first axis.

9. The lighting assembly of claim 8, wherein the second axis is substantially orthogonal to the first axis.

10. The lighting assembly of claim 8, wherein the first axis is substantially horizontal and the second axis is substantially vertical when the lighting assembly is positioned within a luminaire.

11. The lighting assembly of claim 8, wherein the interlocked modules are separable from each other.

12. The lighting assembly of claim 8, wherein the interlocked modules are interlocked via tongue and groove interaction.

13. The lighting assembly of claim 8, wherein the at least one module comprises a thickness and wherein at least some of the channels extend through the thickness of the at least one module.

14. The lighting assembly of claim 8, wherein the fins project laterally outwardly from the first axis.

15. The lighting assembly of claim 8, wherein the second axis is substantially parallel to a direction at which light is emitted from the light source.

16. A method of forming a modular heat sink comprising:
a. extruding at least one module profile in a first direction, wherein the at least one module profile comprises fins defining channels;
b. cutting the at least one module profile to form a plurality of modules each comprising a portion of the fins and the channels of the at least one module profile; and
c. interlocking at least some of the modules together to form the modular heat sink.

17. The method of claim 16, wherein at least a portion of the modular heat sink extends along a first axis and wherein at least some of the channels of at least one of the modules forming the heat sink extend along a second axis different from the first axis.

18. The method of claim 16, further comprising mounting a light source on the modular heat sink.

19. The method of claim 16, wherein the at least one module profile comprises a first module profile and a second module profile different from the first module profile.

20. The method of claim 19, wherein interlocking at least some of the modules together comprises interlocking at least one module cut from the first module profile with at least one module cut from the second module profile.

21. The method of claim 16, wherein the at least one module profile further comprises at least one tongue and at least one groove.

22. The method of claim 21, wherein interlocking at least some of the modules comprises positioning the tongue of one of the modules in the groove of another of the modules.

23. A modular heat sink comprising a plurality of interlocked modules, wherein at least one module comprises a top wall extending in a plane and a plurality of fins defining channels that extend at an angle to the plane.
